(19) United States
(12) Patent Application Publication
(10) Pub. No.: US 2004/0108803 A1
(43) Pub. Date: Jun. 10, 2004

(54) Gas discharge lamp

(76) Inventors: Robert Peter Scholl, Roetgen (DE); Johannes Baier, Wuerselen (DE); Achim Koerber, Kerkrade (NL); Rainer Hilbig, Aachen (DE); Johannes Maria Van Vliet, Eindhoven (NL)

Correspondence Address: Corporate Patent Counsel, Philips Electronics North America Corporation, P O Box 3001, Briarcliff Manor, NY, 10510, US

(21) Appl. No.: 10/479,561

(22) PCT Filed: Jun. 4, 2002
(86) PCT No.: PCT/IB02/02101

(30) Foreign Application Priority Data
Jun. 8, 2001 (DE) 101 27 974.4

(51) Int. Cl. H01J 1/62

(52) U.S. Cl. 313/491

(57) ABSTRACT

A gas discharge lamp is described with at least one capacitive coupling structure (10, 10′), which lamp has the particular feature that the coupling structure (10, 10′) is provided for generating an electromagnetic field with a frequency below approximately 50 MHz, that it is formed by a metal element (101, 101′) surrounded by a dielectric layer (102, 102′) at least in the region of a discharge space, which layer is less than approximately 100 μm thick. It was surprisingly found that operation at low frequencies is possible with such a coupling structure, for which efficient ballasts are available. A further advantage is that this coupling structure compared with known coupling structures for frequencies below approximately 50 MHz only cause a minimum shadow effect. The efficacy of the entire system is considerably higher than that of known lamps of this kind for these two reasons.

The invention relates to a gas discharge lamp with at least one capacitive coupling structure.

Gas discharge lamps of this kind are usually formed by a discharge vessel with two electrodes which are fused into the vessel. A discharge gas is present inside the vessel. Various modes of operation are known for exciting a gas discharge through the emission of electrons.

Apart from the generation of the electrons at so-termed hot electrodes through glow emission or through ion bombardment (ion-induced secondary emission), the gas discharge may be generated in particular through the emission of electrons in a strong electromagnetic field. Capacitive coupling structures are used as the electrodes in such a capacitive mode of operation. These electrodes are formed from a dielectric material which is in contact at one side with the discharge gas and at the other side with an external current circuit with electrical conduction thereto. A high-frequency AC voltage applied to the electrodes generates an electromagnetic AC field in the discharge vessel, in which field the electrons move and excite a gas discharge in a known manner.

Such a discharge lamp is known from WO 94/10701, where the electrodes are formed as rod electrodes which project into a discharge space and which are provided with a dielectric sheath which is impermeable to gas. The purpose of this is on the one hand to concentrate the HF field in the center of the discharge space, so that the interaction between the gas and the wall of the discharge vessel is as weak as possible. On the other hand, it should be avoided that the discharge gas is polluted by electrode material or that the electrodes are attacked or destroyed by the discharge gas. Owing to the low capacitance of the rod electrodes, the frequency of the HF field here lies preferably above 50 MHz, as high as possible frequencies being aimed for in this discharge lamp for reasons of gas dynamics.

It is regarded as disadvantageous here, however, that the operation of such a lamp requires a ballast which has a comparatively low efficiency at high frequencies and thus leads to losses.

It is accordingly an object of the invention to provide a gas discharge lamp of the kind mentioned in the opening paragraph whose overall efficacy is considerably better.

Furthermore, a gas discharge lamp is to be provided which can also be operated with discharge gases which contain a high proportion of aggressive compounds or elements without the electrodes being excessively attacked thereby and lamp life being substantially shortened thereby.

Finally, a gas discharge lamp is to be provided in which the risk of damage caused by differences in coefficients of expansion of the various materials in the operating condition is considerably counteracted.

The solution is achieved by means of a gas discharge lamp with at least one capacitive coupling structure which is characterized, according to claim 1, in that the coupling structure is provided for generating an electromagnetic field with a frequency below 50 MHz, in that said structure is formed by a metal element with a dielectric layer surrounding it at least ion the region of a discharge space, which layer is less than approximately 100 μm thick.

The advantages of this solution are on the one hand that an operation of the gas discharge lamp is also possible at frequencies of, for example, 2.65 MHz or lower, and that thus ballasts may be used which have an efficiency of more than 90% at these frequencies. On the other hand, the coupling structure may be given very small dimensions, so that it blocks out substantially no light. These two properties lead to a considerable rise in the overall efficacy of the lamp.

Since the lamp can be operated also with chemically highly aggressive discharge gases because of the dielectric layer surrounding the metal element, the very good photometric properties that can be generally achieved with such gases can be realized without substantially affecting lamp life.

The dependent claims relate to advantageous further embodiments of the invention.

The embodiments of claims 2 and 7 are eligible for reasons of their simple manufacture and mounting of the coupling structure as well as the particularly small shadow effect.

The materials indicated for the dielectric layer in claim 3 were found to be advantageous as regards their temperature resistance and their comparatively high dielectric constants.

The materials indicated for the wall of the discharge vessel, the dielectric layer, and the metal element in claims 4 to 6 all have substantially the same coefficients of thermal expansion averaged over temperature, so that the risk of damage caused by different expansions of the respective components of the lamp during operation is substantially excluded with these material combinations.

A gas discharge lamp in combination with a ballast as defined in claim 8, finally, has particular economic advantages because ballasts for the frequency range specified therein can be manufactured very inexpensively.

Further details, features, and advantages of the invention will become apparent from the following description of preferred embodiments given with reference to the drawing, in which:

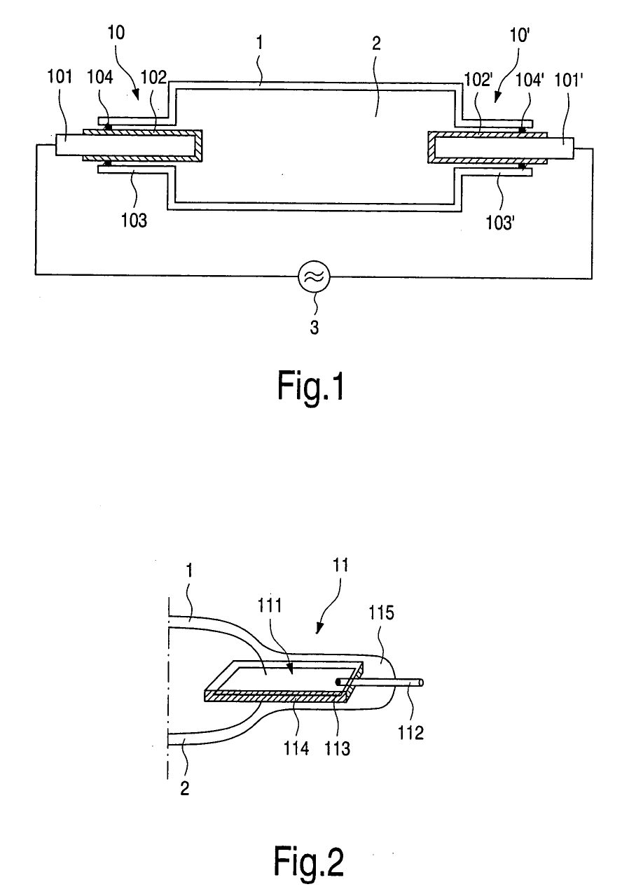

FIG. 1 diagrammatically shows a first embodiment of the invention; and

FIG. 2 diagrammatically shows part of a second embodiment of the invention. The gas discharge lamp shown in FIG. 1 has a substantially tubular discharge vessel 1, for example made of quartz glass, which encloses a discharge space 2 with a discharge gas. The vessel 1 is provided with a capacitive coupling structure 10, 10′ at each of its mutually opposed axial ends, by means of which the high-frequency electromagnetic energy generated by a source with a ballast 3 is coupled into the discharge gas so as to generate a gas discharge.

The discharge gas preferably comprises the following elements and compounds as well as mixtures thereof: sulphur, selenium, tellurium, halides of titanium, zirconium, and hafnium, halides or oxyhalides of niobium and tantalum, halides or oxyhalides of molybdenum and tungsten, Re₂O₇, substances with halide components of the elements aluminum, indium, mercury, and titanium, and substances with halide components as well as chalcogenides of silicon, germanium, selenium, and lead. The advantage of discharge gases composed thereof is that they have very high efficacy and/or color rendering values.

In the first embodiment, the coupling structures 10, 10′ of FIG. 1 are each formed by a metal rod 101, 101′ which is coated with a thin dielectric layer 102, 102′, in particular less than 100 μm thick, at least in the region of the discharge vessel, i.e. there where it is exposed to the discharge gas.

In the second embodiment, of which only the region of one end of the gas discharge lamp is shown in FIG. 2, the coupling structures 11, also capacitive, comprise a metal foil 111 which is connected to a connection pin 112 for the supply of electromagnetic energy. Above and below the metal foil there are respective thin dielectric layers 113, 114, in particular less than 100 μm thick, which together fully enclose the metal foil 111.

The coupling structures 10, 10′; 11 are provided here for the capacitive coupling of a high-frequency electromagnetic AC field with a frequency below 50 MHz, and in particular of 2.65, 13, or 27 MHz, into the discharge gas.

In contrast to the known coupling structures, which have a large surface area for such low frequencies (for example hollow cylindrical coupling structures which surround the discharge space at least partly), which thus cause a considerable shadow effect and render possible an efficiency of the entire system of no more than approximately 60%, the coupling structures according to the invention cause a substantially smaller, or indeed hardly any shadow effect at all.

In addition, the dielectric layers 102, 102′; 113, 114 protect the metal rods 101, 101′ or the metal foil 111 against the chemically highly aggressive discharge gases of the kind mentioned above, so that lamp life is not shortened thereby.

A further advantage of these coupling structures is that ballasts can be used which have a high efficiency at said low frequencies.

The discharge vessels 1 of FIGS. 1 and 2 furthermore each have a substantially tubular extension 103, 103′; 115 at their axial ends, in which one of the coupling structures 10, 10′; 11, respectively, is present. These structures are fastened or fused therein in a gas tight manner by means of glass enamel 104, 104′. The coupling structures are thus recessed with respect to the discharge vessel and only project into this vessel with their respective free ends. This has the advantage that the shadow effect of the coupling structures is particularly small.

Materials are used for the thin dielectric layers 102, 102′; 113, 114 which render possible a particularly efficient operation at frequencies below 50 MHz, and in particular at 2.65, 13, and 27 MHz. The layers here have a thickness of less than 100 μm. Very high overall efficacies (of lamp plus ballast) can be achieved with such a coupling structure. This is true in particular for a frequency of 2.65 MHz, for which ballasts are available with more than 90% efficiency.

The following elements and compounds have proved to be particularly advantageous as dielectric materials: the oxides of magnesium, potassium, strontium, barium, scandium, yttrium, lanthanum, rare earth oxides, the oxides of titanium, zirconium, hafnium, thorium, niobium, tantalum, chromium, aluminum, and silicon, as well as the nitrides of aluminum, gallium, indium, and silicon, or the oxynitrides thereof, as well as dielectric sulphides or selenides. Combinations of these materials are also possible such as, for example, MgTiO₃ (εᵣ=12), CaTiO₃ (εᵣ=168), SrTiO₃ (εᵣ=300).

Table 1 below lists a plurality of dielectric materials with their boiling points, which are a measure for the temperature resistance, their dielectric constants εᵣ, and the coefficients of thermal expansion α:

TABLE 1

| | Boiling point | Dielectr. const. | |
|---|---|---|---|
| Dielectric: | [K]: | εᵣ: | Coeff. of exp. α [10⁻⁶ 1/K]: |
| MgO | 3873 | 9, 7 | 14 [293-1673] |
| CaO | 3773 | | 13, 7 [293-1673] |
| SrO | 3300 | | |
| BaO | 2300 | | |
| Sc₂O₃ | | | |
| Y₂O₃ | | 13 | 9, 3 [273-1273] |
| La₂O₃ | 4473 | | |
| CeO₂ | 3500 | 15-26 | 8, 5 [293-1273] |
| rare earth ox. | 3000-4000 | | typically 8-10 [293-1273] |
| TiO₂ | 3200 | 80-90 | 7-8 [293-873] |
| ZrO₂ | 4573 | 8-12 | 8 [473-1353] |
| HfO₂ | | 12 | 6, 45 [293-1973] |
| ThO₂ | 4673 | | 9, 5 [293-1673] |
| VO₂ or V₂O₅ | 3300 or 2325 | | |
| Nb₂O₅ | 3200 | 280 | |
| Ta₂O₅ | | 22 | 2, 8 |
| Cr₂O₃ | 3273 | | 9, 6 [293-1673] |
| Al₂O₃ | 3253 | 10 | 8 [293-1673] |
| SiO₂ | 2250 | 4 | 0, 5 [293-1523] |
| AlN | 2300 | 8, 5 | 4-5 |
| Si₃N₄ | | | 2, 4 |
| CaS | | | 17 |

It should be heeded in the choice of materials that they should have as high as possible a dielectric constant and a temperature resistance sufficient for the lamp in question.

In addition, the coefficients of thermal expansion of the metal rod or the metal foil and the dielectric material must substantially correspond, because otherwise there will be a risk of cracks arising in the dielectric layer.

In addition, the material of the dielectric layer 102, 102′; 113, 114 and of the metal rod 101, 101′ or metal foil 111 must fulfill the condition that the coefficient of thermal expansion averaged over temperature corresponds approximately to the coefficient of expansion of the discharge vessel 1, because otherwise there will be the risk of cracks arising at the transitions between the discharge vessel and the dielectric layer. In this respect, suitable wall materials for the discharge vessel were found to be, besides quartz and densely sintered aluminum oxide (Al₂O₃), AlN and YAG (Y₃Al₅O₁₂).

Table 2 lists a few material combinations for the wall of the discharge vessel 1, the dielectric layers 102, 102′; 113, 114, and the metal of the metal rods 101, 101′ or the metal foil 111, which are advantageous as regards the highest possible similarity of coefficients of thermal expansion.

TABLE 2

| Wall material: | Dielectric: | Metal: |
|---|---|---|
| PCA = Al₂O₃ | Al₂O₃ or all dielectrics with a | Nb or |
| | coefficient of expansion averaged - | Pt, Ta, Re |
| | over temperature of approximately | |
| | 8 * 10⁻⁶ 1/K such as: | |
| | TiO₂, Y₂O₃, ZrO₂, HfO₂, CeO₂, ThO₂, | |
| | Cr₂O₃, and rare earth oxides | |
| Quartz | Ta₂O₅ or SiO₂, or Si₃N₄ | thin foil of |
| | | Mo or W |
| AlN | AlN or mixtures of HfO₂ and Ta₂O₅ | Mo or W |

The risk of damage caused by differences in expansion of said parts is substantially excluded with these material combinations also at very strong temperature fluctuations.

1. A gas discharge lamp with at least one capacitive coupling structure, characterized in that the coupling structure (10, 10′; 11) is provided for generating an electromagnetic field with a frequency below 50 MHz, in that said structure is formed by a metal element (101, 101′; 111) with a dielectric layer (102, 102′; 113, 114) surrounding it at least in the region of a discharge space (2), which layer is less than approximately 100 μm thick.

2. A gas discharge lamp as claimed in claim 1, characterized in that the metal element is formed by a metal rod (101, 101′) or a metal foil (111) projecting into a discharge space (2).

3. A gas discharge lamp as claimed in claim 1, characterized in that the dielectric layer is formed by one or several of the following materials: oxides of magnesium, potassium, strontium, barium, scandium, yttrium, lanthanum, rare earth oxides, oxides of titanium, zirconium, hafnium, thorium, niobium, tantalum, chromium, aluminum, and silicon, nitrides of aluminum, gallium, indium, and silicon, or the oxynitrides thereof, as well as dielectric sulphides and selenides.

4. A gas discharge lamp as claimed in claim 1, characterized in that the material for the wall of a discharge vessel of the lamp is Al₂O₃, the material for the dielectric layer is Al₂O₃ or dielectrics with TiO₂, Y₂O₃, ZrO₂, HfO₂, CeO₂, ThO₂, Cr₂O₃, or rare earth oxides, and the material for the metal element is niobium, platinum, tantalum, or rhenium.

5. A gas discharge lamp as claimed in claim 1, characterized in that the material for the wall of a discharge vessel of the lamp is quartz, the material for the dielectric layer is Ta₂O₅ or SiO₂, or Si₃N₄, and the material for the metal element is a molybdenum or a tungsten foil.

6. A gas discharge lamp as claimed in claim 1, characterized in that the material for the wall of a discharge vessel of the lamp is AlN, the material for the dielectric layer is AlN or a mixture of HfO₂ and Ta₂O₅, and the material for the metal element is molybdenum or tungsten.

7. A gas discharge lamp as claimed in claim 1, characterized by a substantially tubular discharge vessel (1) which has an extension (103, 103′; 115) at each of its axial ends, one of the coupling structures (10, 10′; 11) being arranged in each of said extensions such that said structures project into the discharge vessel only in the regions of their free ends.

8. A gas discharge lamp as claimed in claim 1 with a ballast for generating a supply voltage for the lamp with a frequency of less than approximately 50 MHz from a public mains voltage.
